(19) United States
(12) Patent Application Publication
(10) Pub. No.: US 2007/0024565 A1
(43) Pub. Date: Feb. 1, 2007

(54) Display device, method of driving the same and driving device for driving the same

(75) Inventor: Seong-Sik Choi, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 11/436,781

(22) Filed: May 18, 2006

(30) Foreign Application Priority Data
Jul. 30, 2005 (KR) 2005-69948

(51) Int. Cl. G09G 3/36

(52) U.S. Cl. 345/98

(57) ABSTRACT

A display device includes a display panel, a driving unit, a common voltage generating unit and a first compensating unit. The display panel includes a plurality of pixel units. Each of the pixel units has a switching element and a storage capacitor electrically connected to the switching element. The driving unit applies a driving signal to the switching element. The common voltage generating unit applies a first common voltage to the storage capacitor. The first compensating unit compensates for a distorted portion of the first common voltage based on a fed back first common voltage from the display panel.

### CROSS-REFERENCE TO RELATED APPLICATIONS

The present application claims priority from Korean Patent Application No. 2005-69948, filed on Jul. 30, 2005, the disclosure of which is incorporated herein by reference in its entirety.

### BACKGROUND OF THE INVENTION

1. Field of the Invention

The present invention relates to a driving device for driving a display device and a method of driving the display device.

2. Description of the Related Art

A display device is used for electric devices such as monitors, notebook computers, television receivers, and mobile communication terminals. A flat panel display device is a type of display device that includes characteristics such as lightness and thinness.

A liquid crystal display (LCD) device is a type of flat panel display device that displays an image using liquid crystals. The liquid crystals vary in arrangement in response to an electric field applied thereto, thus the light transmittance of the liquid crystals is changed, thereby displaying the image.

The LCD device is used for rapidly expanding applications such as notebook computers, monitors, televisions, and mobile communication terminals. Accordingly, image quality of the LCD device is continuing to improve.

The LCD device, in general, includes an LCD panel and a driving device for driving the LCD panel. The LCD panel includes an array substrate, an opposite substrate and a liquid crystal layer. The liquid crystal layer is interposed between the array substrate and the opposite substrate. The array substrate includes a plurality of data lines and a plurality of gate lines. The gate lines cross the data lines and define the locations of a plurality of pixels.

Each of the pixels includes a switching element, a liquid crystal capacitor and a storage capacitor. A first electrode of the liquid crystal capacitor is a pixel electrode that is electrically connected to a drain electrode of the switching element. A second electrode of the liquid crystal capacitor is a common electrode located on the opposite substrate.

When a gate signal is applied to one of the gate lines, a gate electrode of the switching element activates the switching element such that a data signal applied to one of the data lines is then applied to the pixel electrode through the source electrode of the switching element.

When the data signal is applied to the pixel electrode that is the first electrode of the storage capacitor, a direct current voltage is applied to the second electrode of the storage capacitor to maintain a voltage difference between the pixel electrode and the common electrode. In particular, an electric charge is stored in the liquid crystal capacitor and the storage capacitor by the data signal applied to the liquid crystal capacitor and the storage capacitor, respectively. The liquid crystals vary in arrangement in response to the electric field formed in the liquid crystal capacitor, thus the light transmittance of the liquid crystal layer is changed, thereby displaying an image using an internally or externally provided light.

When a direct current voltage is constantly applied to the second electrode of the storage capacitor, a portion of the electric charge remains in each of the pixels. The remaining electric charge forms a latent image effect and deteriorates the image display quality.

### SUMMARY OF THE INVENTION

A display device in accordance with one embodiment of the present invention includes a display panel, a driving unit, a common voltage generating unit and a first compensating unit. The display panel includes a plurality of pixel units. Each of the pixel units has a switching element and a storage capacitor electrically connected to the switching element. The driving unit applies a driving signal to the switching element. The common voltage generating unit applies a first common voltage to the storage capacitor. The first compensating unit compensates for a distorted portion of the first common voltage based on a fed back first common voltage from the display panel.

A method of driving a display device is provided for a display device that includes a display panel having a plurality of pixel units. Each of the pixel units includes a switching element, a liquid crystal capacitor electrically connected to the switching element and a storage capacitor. An analog driving voltage is generated. A first common voltage is applied to the storage capacitor and a second common voltage is applied to the liquid crystal capacitor, wherein each voltage is based on the driving voltage. A distorted portion of the first common voltage applied to the display panel is fed back. The distorted portion of the first common voltage is compensated based on a first amplifying ratio.

A driving device for driving a display device includes a display panel that displays an image based on data and gate signals, and a first common voltage. The driving device includes a data driving unit, a gate driving unit, a driving voltage generating unit and a compensating unit. The data driving unit generates a data signal. The gate driving unit generates a gate signal. The driving voltage generating unit generates an analog driving voltage. The compensating unit applies a first common voltage to the display panel based on the analog driving voltage, receives feedback from the first common voltage, and outputs a first compensation signal that compensates for a distorted portion of the first common voltage using the feedback from the first common voltage.

### BRIEF DESCRIPTION OF THE DRAWINGS

Exemplary embodiments of the present invention can be understood in more detail from the following descriptions taken in conjunction with the accompanying drawings, in which:

FIG. 1 is a block diagram illustrating a display device in accordance with an exemplary embodiment of the present invention;

FIG. 2 shows a plan view illustrating an array substrate of FIG. 1;

FIG. 3 is a timing diagram illustrating a data signal applied to a data line and a first common voltage applied to a first common electrode of FIG. 2;

FIG. 4 is a timing diagram illustrating a data signal applied to a data line and a first common voltage applied to a first common electrode in accordance with an exemplary embodiment of the present invention;

FIG. 5 is a block diagram illustrating a compensating unit in accordance with an exemplary embodiment of the present invention;

FIG. 6 is a block diagram illustrating a compensating unit in accordance with an exemplary embodiment of the present invention;

FIG. 7 is a circuit diagram illustrating a compensating unit in accordance with an exemplary embodiment of the present invention;

FIG. 8 is a timing diagram illustrating a compensation signal output from the compensating unit of FIG. 6;

FIG. 9 shows a plan view illustrating horizontal crosstalk;

FIG. 10 is a timing diagram illustrating the horizontal crosstalk of FIG. 9; and

FIG. 11 shows a plan view illustrating a method of determining an amount of distortion of a common electrode for forming a compensating unit.

### DESCRIPTION OF EXEMPLARY EMBODIMENTS

The invention is described more fully hereinafter with reference to the accompanying drawings, in which embodiments of the invention are shown. This invention may, however, be embodied in many different forms and should not be construed as limited to the embodiments set forth herein. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present.

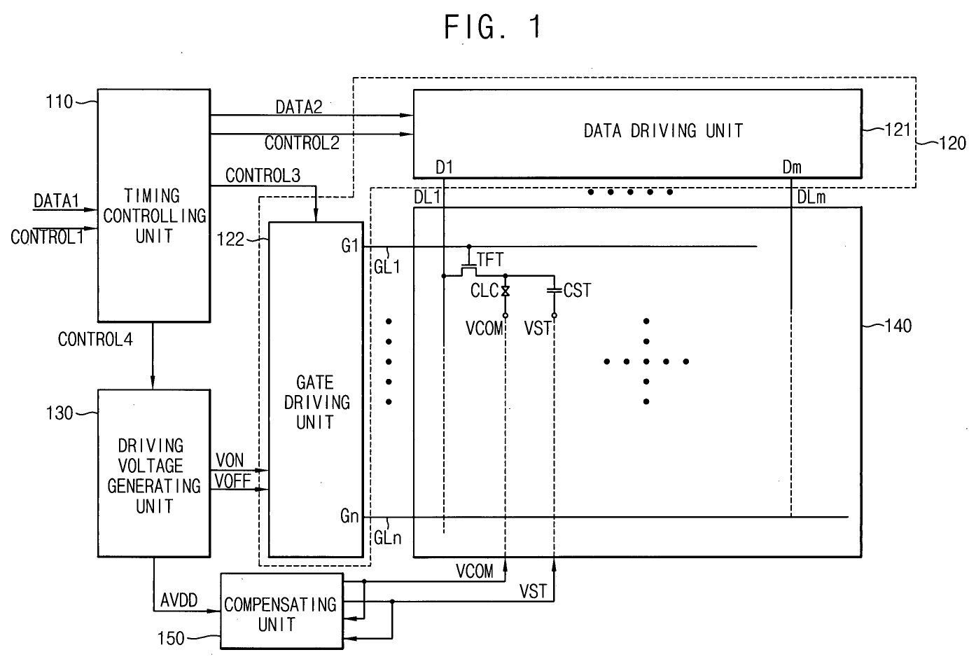

FIG. 1 is a block diagram illustrating a display device in accordance with an exemplary embodiment of the present invention.

Referring to FIG. 1, the display device includes a timing controlling unit 110, a driving unit 120, a driving voltage generating unit 130 and a display panel 140.

The timing controlling unit 110 generates a second control signal CONTROL2, a third control signal CONTROL3 and a fourth control signal CONTROL4 based on a first control signal CONTROL1 that is from an externally provided graphic unit (not shown). In addition, the timing controlling unit 110 controls timing of a first data signal DATA1 to apply a second data signal DATA2 to the driving unit 120. Each of the first and second data signals DATA1 and DATA2 is digital.

The first control signal CONTROL1 includes a main clock signal MCKL, a horizontal synchronization signal HSYNC and a vertical synchronization signal VSYNC. The second control signal CONTROL2 includes a horizontal start signal STH, a signal REV and a data load signal TP for controlling the driving unit 120. The third control signal CONTROL3 includes a vertical start signal STV, a clock signal CK and an output enable signal OE for controlling the driving unit 120. The fourth control signal CONTROL4 includes a vertical synchronization signal VSYNC and a signal REV for controlling the driving voltage generating unit 130.

The driving unit 120 includes a data driving unit 121 and a gate driving unit 122. The data driving unit 121 changes the second data signal DATA2 into analog data signals D1, D2, . . . Dm based on the second control signal CONTROL2 to apply the analog data signals D1, D2, . . . Dm to data lines DL1, DL2, . . . DLm of the display panel 140.

The gate driving unit 122 generates gate signals G1, G2, . . . Gn based on the third control signal CONTROL3 to apply the gate signals G1, G2, . . . Gn to the gate lines GL1, GL2, . . . GLn of the display panel 140.

The driving voltage generating unit 130 generates a gate on voltage VON, a gate off voltage VOFF, a first common voltage VST and a second common voltage VCOM. The gate on voltage VON and the gate off voltage VOFF are applied to the gate driving unit 122. The first and second common voltages VST and VCOM are applied to the display panel 140. Each of the first and second common voltages VST and VCOM is a direct current voltage having a constant level.

The display panel 140 includes an array substrate, an opposite substrate and a liquid crystal layer. The liquid crystal layer is interposed between the array substrate and the opposite substrate. The array substrate includes a plurality of data lines DL1, DL2, . . . DLm, a plurality of gate lines GL1, GL2, . . . GLn and a plurality of pixels. The pixels are defined by the gate lines GL1, GL2, . . . GLn and the data lines DL1, DL2, . . . DLm adjacent to each other. Each of the pixels includes a switching element TFT, a liquid crystal capacitor CLC and a storage capacitor CST. A gate electrode of the switching element TFT is electrically connected to one of the gate lines GL1, GL2, . . . GLn. A source electrode of the switching element TFT is electrically connected to one of the data lines DL1, DL2, . . . DLm. A drain electrode of the switching element TFT is electrically connected to the first electrode of the liquid crystal capacitor CLC and the first electrode of the storage capacitor CST.

The opposite substrate includes a color filter and a second common electrode EV2 that is the second electrode of the liquid crystal capacitor CLC.

The first driving voltage VST that is generated from the driving voltage generating unit 130 is applied to a first common electrode EV1 that is the second electrode of the storage capacitor CST. The second common voltage VCOM that is generated from the driving voltage generating unit 130 is applied to the second electrode of the liquid crystal capacitor CLC.

The display device may further include a compensating unit 150. The compensating unit 150 generates a first compensation signal Vre1 and a second compensation signal Vre2 to compensate for the first and second common voltages VST and VCOM that may be distorted in the display panel 140.

Hereinafter, the compensating unit 150 is described.

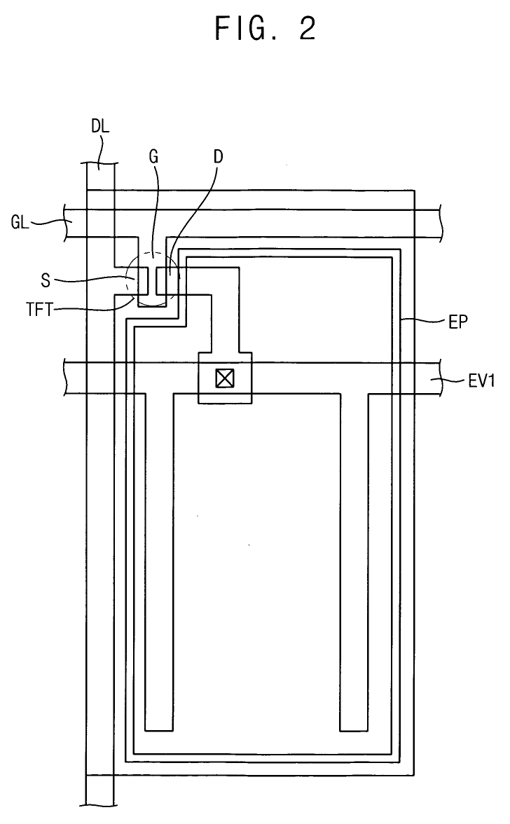

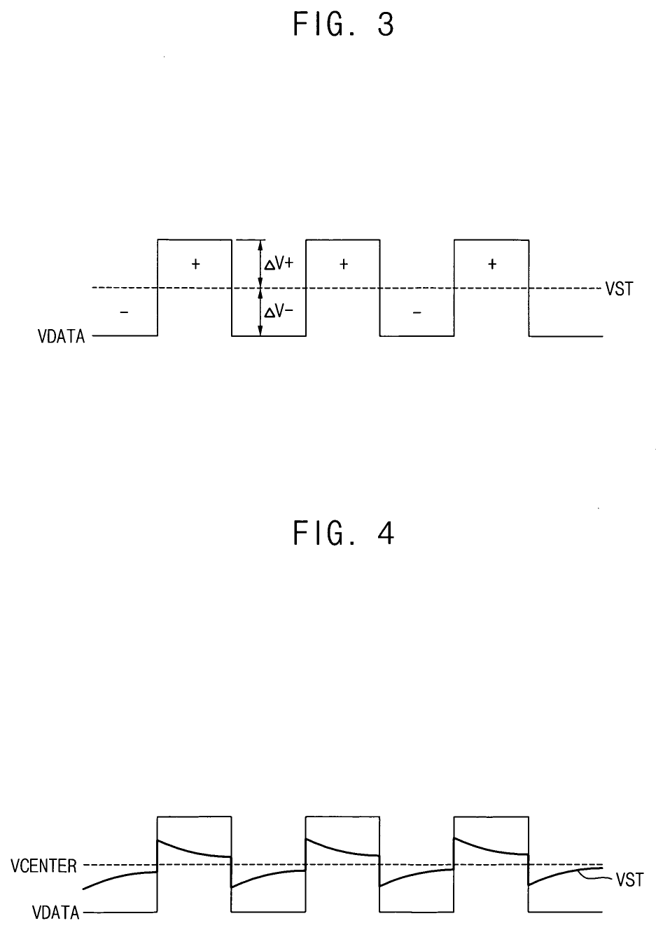

FIG. 2 shows a plan view illustrating a pixel of an array substrate of FIG. 1. FIG. 3 is a timing diagram illustrating a data signal applied to a data line and a first common voltage applied to a first common electrode of FIG. 2. FIG. 4 is a timing diagram illustrating a data signal applied to a data line and a first common voltage applied to a first common electrode in accordance with an exemplary embodiment of the present invention.

Referring to FIG. 2, the pixel includes a data line DL, a gate line GL, a switching element TFT, a pixel electrode EP and a first common electrode EV1. The pixel may further include a liquid crystal capacitor CLC (shown in FIG. 1) and a storage capacitor CST (shown in FIG. 1).

The switching element TFT is formed near an intersection where the data line DL crosses the gate line GL. A gate electrode G of the switching element TFT is electrically connected to the gate line GL. A source electrode S of the switching element TFT is electrically connected to the data line DL. A drain electrode D of the switching element TFT is electrically connected to the pixel electrode EP that is a first electrode of the liquid crystal capacitor CLC and a first electrode of the storage capacitor CST.

A second electrode of the storage capacitor CST is electrically connected to the first common electrode EV1. The storage capacitor CST stores an electric charge formed from the data signal to maintain a voltage difference between the pixel electrode EP and the first common electrode EV1 for one frame, thereby displaying an image.

Referring to FIG. 3, a positive voltage level and a negative voltage level of a data signal are alternately applied to the data line DL to reduce deterioration of liquid crystals. Alternatively, the first common voltage VST may include a plurality of first common voltage portions having varied levels. A level of the first common voltage VST may be adjusted, so the positive voltage level of the data signal is substantially equal to the negative voltage level of the data signal with respect to the first common voltage VST, thereby decreasing a latent image effect.

However, an electromagnetic coupling may be formed between the first common voltage VST applied to the first common electrode EV1 and the data signal applied to the data line DL. Therefore, in FIG. 4, a parasitic capacitance is formed between the first common electrode EV1 and the data line DL, thereby distorting the first common voltage VST.

In addition, the amount of distortion is changed by an RC delay of the data and gate lines. The RC delay is changed with respect to the location of the data and gate lines.

That is, the positive and negative voltage levels of the data signal are alternately applied to the data line DL, and the level of the first common voltage VST is adjusted, so the positive voltage level of the data signal is substantially equal to the negative voltage level of the data signal with respect to the first common voltage VST. However, the electromagnetic coupling is formed between the first common voltage VST and the data signal to distort the first common voltage VST.

Furthermore, the amount of distortion is changed with respect to the location of the data and gate lines by the RC delay.

Therefore, when the level of the first common voltage VST is adjusted to reduce the latent image effect, the first common voltage VST is distorted with respect to the location of the data and gate lines DL and GL.

Therefore, the display device benefits from a compensating unit to compensate for the distortion of the first common voltage VST.

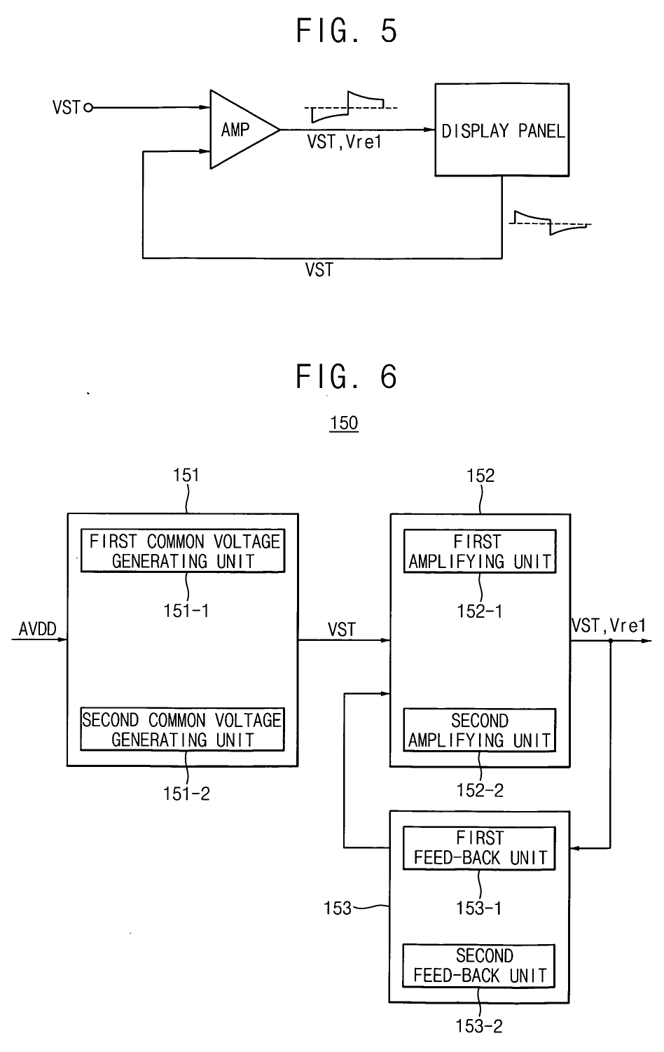

FIG. 5 is a block diagram illustrating a compensating unit in accordance with an exemplary embodiment of the present invention.

Referring to FIG. 5, the compensating unit receives feedback from a distorted first common voltage VST from a display panel, and reverses a phase of the distorted first common voltage VST. For example, the compensating unit reverses a phase of the distorted first common voltage VST by about 180 degrees. The reversed distorted first common voltage VST is amplified to form a first compensation signal Vre1. The first compensation signal Vre1 is applied to the display panel.

Therefore, the distorted first common voltage VST is compensated by the first compensation signal Vre1, so the first common voltage VST may have a constant level.

FIG. 6 is a block diagram illustrating a compensating unit in accordance with an exemplary embodiment of the present invention.

Referring to FIG. 6, the compensating unit 150 includes a common voltage generating unit 151 and an amplifying unit 152. The compensating unit 150 may further include a feedback unit 153.

The common voltage generating unit 151 includes a first common voltage generating unit 151-1. The first common voltage generating unit 151-1 generates a first common voltage VST based on an analog driving voltage AVDD output from a driving voltage generating unit 130 (shown in FIG. 1). A level of the driving voltage AVDD may be divided to generate the first common voltage VST.

The common voltage generating unit 151 may further include a second common voltage generating unit 151-2. The second common voltage generating unit 151-2 generates a second common voltage VCOM (shown in FIG. 1) based on the analog driving voltage AVDD output from the driving voltage generating unit 130 (shown in FIG. 1). Alternatively, the second common voltage VCOM may include a plurality of second common voltage portions having varied levels. The level of the driving voltage AVDD may be divided to generate the second common voltage VCOM.

Referring again to FIGS. 1 and 6, the amplifying unit 152 includes a first amplifying unit 152-1. The first amplifying unit 152-1 applies the first common voltage VST to the display panel 140. The first common voltage VST applied to the display panel 140 is distorted with respect to a location on the display panel 140. The amount of distortion is changed with respect to an RC delay of the data line or the gate line. In addition, the amount of distortion may be increased by an electromagnetic coupling between a data signal and the first common voltage VST.

The first amplifying unit 152-1 receives feedback from the distorted first common voltage VST. For example, the first compensation signal Vre1 is generated using a subtraction of the fed back first common voltage VST from a primary first common voltage VST that is generated from the first common voltage generating unit 151-1. The first amplifying unit 152-1 may amplify and reverse the subtracted signal to generate the first compensation signal Vre1. For example, the first amplifying unit 152-1 reverses a phase of the subtracted signal by about 180 degrees. The first compensation signal Vre1 is applied to the display panel 140.

A distorted portion of the first common voltage VST applied to the display panel 140 is compensated by the first compensation signal Vre1 to reduce a latent image effect.

The feedback unit 153 includes a first feedback unit 153-1. The first feedback unit 153-1 extracts the distorted portion of the first common voltage VST from the display panel 140. The extracted distorted portion is applied to the first amplifying unit 152-1.

In addition, the amplifying unit 152 may further include a second amplifying unit 152-2. The second amplifying unit 152-2 applies the second common voltage VCOM to the display panel 140. The second common voltage VCOM applied to the display panel 140 is distorted. The second amplifying unit 152-2 receives feedback from the distorted second common voltage VCOM. A second compensation signal Vre2 is generated using a subtraction of the fed back second common voltage VCOM from a primary second common voltage VCOM that is generated from the second common voltage generating unit 151-2. The second amplifying unit 152-2 may amplify and reverse the subtracted signal to generate the second compensation signal Vre2. For example, the second amplifying unit 152-2 reverses a phase of the subtracted signal by about 180 degrees. The second compensation signal Vre2 is applied to the display panel 140. A distorted portion of the second common voltage VCOM applied to the display panel 140 is compensated by the second compensation signal Vre2 to reduce the latent image effect.

The feedback unit 153 may further include a second feedback unit 153-2. The second feedback unit 153-2 extracts the distorted portion of the second common voltage VCOM from the display panel 140. The extracted distorted portion is applied to the second amplifying unit 152-2.

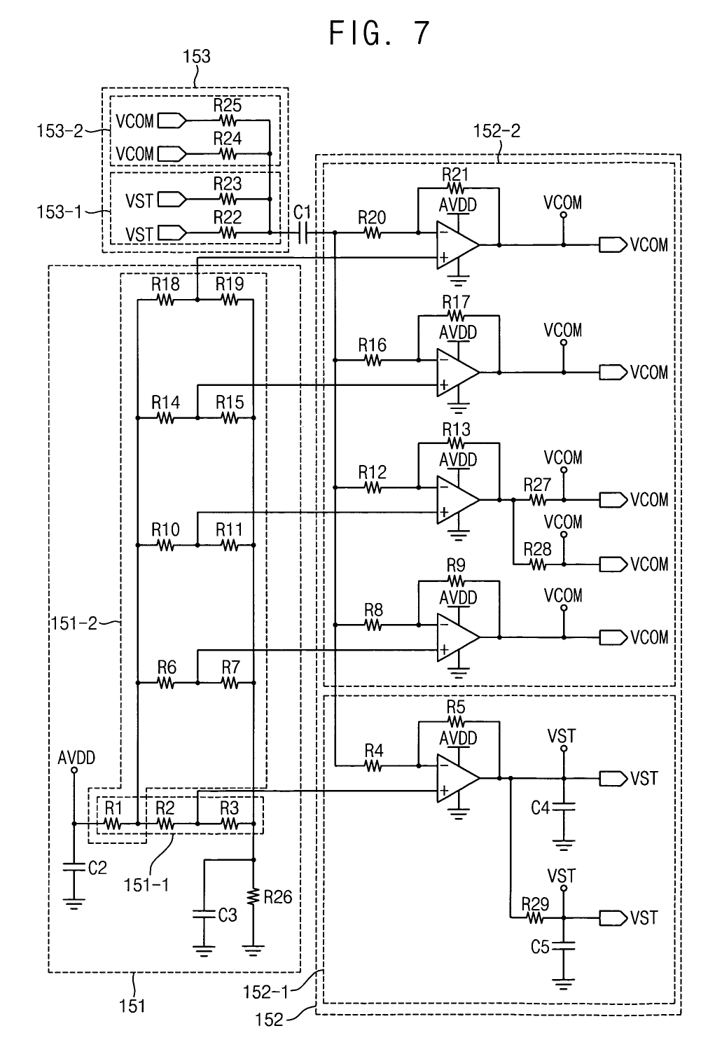

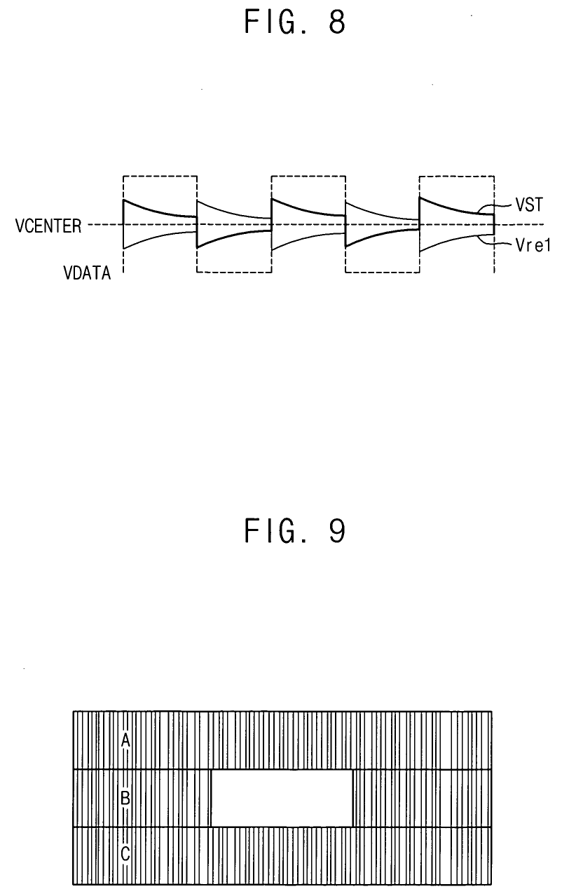

FIG. 7 is a circuit diagram illustrating a compensating unit in accordance with an exemplary embodiment of the present invention. FIG. 8 is a timing diagram illustrating a compensation signal output from the compensating unit of FIG. 6.

Referring to FIGS. 1 and 7, the compensating unit 150 includes the common voltage generating unit 151, the amplifying unit 152 and the feedback unit 153.

The common voltage generating unit 151 generates the first common voltage VST based on the analog driving voltage AVDD output from the driving voltage generating unit 130. The level of the driving voltage AVDD may be divided to generate the first common voltage VST that has an optimized level. The common voltage generating unit 151 includes the first common voltage generating unit 151-1 having a resistor string. The resistor string includes a plurality of resistors R1, R2 and R3.

The first common voltage generating unit 151-1 divides the analog driving voltage AVDD to form the optimized first common voltage VST based on an amount of distortion of a first common voltage VST that is applied to the display panel 140.

For example, a level of the first common voltage VST is adjusted by the first resistor R1 and a composite resistance of the second and third resistors R2 and R3. The adjusted level of the first common voltage VST is optimized by the second and third resistors to generate the optimized first common voltage VST.

In addition, the common voltage generating unit 151 may further include a second common voltage generating unit 151-2 having a resistor string to generate the second common voltage VCOM. The resistor string of the second common voltage generating unit 151-2 includes a plurality of resistors.

The second common voltage generating unit 151-2 divides the analog driving voltage AVDD to form an optimized second common voltage VCOM based on the amount of distortion of a second common voltage VCOM that is applied to the display panel 140.

The amplifying unit 152 includes the first amplifying unit 152-1. The first amplifying unit 152-1 receives feedback from the distorted first common voltage VST. A first compensation signal Vre1 is generated using a subtraction of the fed back first common voltage VST from the optimized first common voltage VST that is generated from the first common voltage generating unit 151-1. The first amplifying unit 152-1 may amplify and reverse the subtracted signal to generate the first compensation signal Vre1. For example, the first amplifying unit 152-1 reverses a phase of the subtracted signal by about 180 degrees.

For example, the first amplifying unit 152-1 may include an operational amplifier. The operational amplifier receives the first common voltage VST that is output from the common voltage generating unit 151 through a positive input terminal of the operational amplifier. The operational amplifier receives the distorted first common voltage VST through a negative input terminal. An output terminal of the operational amplifier is electrically connected to the negative input terminal.

A fifth resistor R5 is electrically connected between the output terminal and the negative input terminal of the operational amplifier. A fourth resistor R4 is electrically connected to the negative input terminal to control a composite resistance of the fourth and fifth resistors R4 and R5, thereby controlling a first amplifying ratio of the first amplifying unit 152-1.

In addition, the amplifying unit 152 may further include the second amplifying unit 152-2. The second amplifying unit 152-2 receives feedback from the distorted second common voltage VCOM. A second compensation signal Vre2 is generated using a subtraction of the fed back second common voltage VCOM from the optimized second common voltage VCOM that is generated from the second common voltage generating unit 151-2. The second amplifying unit 152-2 may amplify and reverse the subtracted signal to generate the second compensation signal Vre2. For example, the second amplifying unit 152-2 reverses a phase of the subtracted signal by about 180 degrees.

For example, the second amplifying unit 152-2 may include an operational amplifier. The resistance of resistors of the operational amplifier of the second amplifying unit 152-2 is controlled to adjust a second amplifying ratio. The second amplifying unit 152-2 is substantially the same as the first amplifying unit 152-1, and thus any further explanation concerning the above elements will be omitted.

Referring to FIGS. 6 to 8, the first amplifying unit 152-1 subtracts the distorted first common voltage VST from the first common voltage VST that is output from the common voltage generating unit 151 to output the first compensation signal Vre1.

The first compensation signal Vre1 is an amplified signal of an alternating portion of the first common voltage VST. A phase of the first compensation signal Vre1 may be substantially opposite to the distorted portion of the first common voltage VST. That is, the first amplifying unit 152-1 may amplify and reverse a phase of the distorted portion of the first common voltage VST to generate the first compensation signal Vre1. For example, the first amplifying unit 152-1 reverses a phase of the distorted portion of the first common voltage VST. The first compensation signal Vre1 is distorted to compensate for the distorted portion of the first common voltage VST.

Therefore, the first common voltage VST applied to the display panel 140 has substantially the same level as the first common voltage VST output from the common voltage generating unit 151, thereby removing the distortion of the first common voltage VST. For example, the first common voltage VST applied to the display panel 140 may have a constant level.

The feedback unit 153 receives the distorted first common voltage VST to apply the distorted first common voltage VST to the first amplifying unit 152-1. In addition, the feedback unit 153 may further include a capacitor C1 that extracts the distorted portion of the distorted first common voltage VST, which is an alternating current.

When the first amplifying unit 152-1 is electrically connected to a plurality of voltage receiving terminals of the display panel 140, the feedback unit 153 receives a plurality of distorted first common voltages from the voltage receiving terminals to apply the distorted first common voltages to the first amplifying unit 152-1.

In addition, when the second amplifying unit 152-2 is electrically connected to a plurality of voltage receiving terminals of the display panel 140, the feedback unit 153 receives a plurality of distorted second common voltages from the voltage receiving terminals to apply the distorted second common voltages to the second amplifying unit 152-2. Alternatively, the second amplifying unit 152-2 may be electrically connected to the voltage receiving terminals of the display panel 140, and the feedback unit 153 may selectively receive the distorted first common voltages or the distorted second common voltages from the voltage receiving terminals to apply the distorted first common voltages or the distorted second common voltages to the first amplifying unit 152-1 or the second amplifying unit 152-2.

The capacitor C1 of the feedback unit 153 may be electrically connected to the voltage applying terminals receiving the first and second common voltages VST and VCOM.

The voltage applying terminals that receive the first and second common voltages VST and VCOM are on portions of the display panel 140 to compensate for the amounts of distortion with respect to the location of the voltage applying terminals. For example, the first and second common voltages VST and VCOM may have varied levels, and the first and second common voltages VST and VCOM having varied levels are applied to the voltage applying terminals of various locations, respectively.

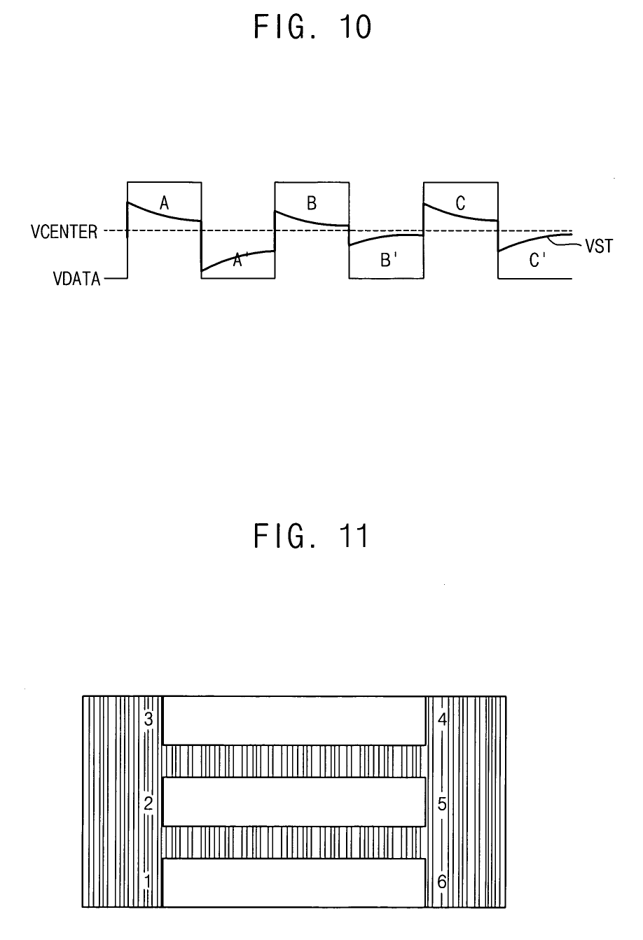

FIG. 9 shows a plan view illustrating horizontal crosstalk. FIG. 10 is a timing diagram illustrating the horizontal crosstalk of FIG. 9. FIG. 11 shows a plan view illustrating a method of determining an amount of distortion of a common electrode for forming a compensating unit.

Referring again to FIGS. 1, 6 and 7, locations of voltage receiving terminals receiving first and second common voltages VST and VCOM and feedback location of the first and second common voltages VST and VCOM are on a peripheral region of a display panel 140 corresponding to a black matrix. Therefore, distortion amounts of the first and second common voltages VST and VCOM may not be easily detected.

Referring to FIG. 9, however, the distortion amounts of the first and second common voltages VST and VCOM are detected through a method for decreasing horizontal crosstalk.

Hereinafter, the method for decreasing the horizontal crosstalk is described.

The first common voltage VST that is applied to the first common electrode EV1 is distorted by parasitic capacitance between the first common electrode EV1 and the data line DL. The amount of distortion is changed by a white box-shaped image or a black box-shaped image.

The horizontal crosstalk may be formed as follows.

To test the display panel, the white box-shaped image or the black box-shaped image is displayed in a predetermined region of the display panel. The amount of distortion of the first common voltage VST in peripheral regions A, B and C adjacent to the whit box-shaped image is shown in FIG. 10. The distortion amount of the first common voltage VST in the peripheral region B is smaller than that of each of the first common voltages VST in the peripheral regions A and C, so a level of the first common voltage VST in the peripheral region A is increased. Therefore, the luminance on each of the interfaces among the peripheral regions A, B and C is greatly changed, thereby deteriorating image display quality.

Referring to FIG. 11, a plurality of white box-shaped images or a plurality of black box-shaped images is displayed in a plurality of regions of the display panel to detect luminance levels on first, second, third, fourth, fifth and sixth points 1, 2, 3, 4, 5 and 6. The luminance levels on the first, second, third, fourth, fifth and sixth points 1, 2, 3, 4, 5 and 6 may not be greatly changed, thereby easily determining the distortion amount of the first common voltages VST on first, second, third, fourth, fifth and sixth points 1, 2, 3, 4, 5 and 6.

Hereinafter, a method of compensating for the distortion amount is described.

Table I represents a relationship between a location of a point and a distortion amount before compensation of a distortion amount.

TABLE I

| Number | Box-Shaped Image | | Horizontal Crosstalk |
|---|---|---|---|
| of Point | (Yes/No) | Luminance | (%) |
| 1 | Yes | 32.86 | 10.53 |
| | No | 29.73 | |
| 2 | Yes | 32.11 | 7.64 |
| | No | 29.83 | |
| 3 | Yes | 29.95 | 1.29 |
| | No | 29.57 | |
| 4 | Yes | 28.63 | 2.54 |
| | No | 27.92 | |
| 5 | Yes | 27.51 | 7.00 |
| | No | 27.71 | |
| 6 | Yes | 27.27 | 9.30 |
| | No | 24.95 | |

Referring to Table I, the luminance levels on the first, second, third, fourth, fifth and sixth points 1, 2, 3, 4, 5 and 6 are detected with respect to the box-shaped images to determine the amounts of the horizontal crosstalk on the first, second, third, fourth, fifth and sixth points 1, 2, 3, 4, 5 and 6.

The resistors of the first amplifying unit 152-1 (shown in FIG. 7) are adjusted to compensate for the distortion amounts of the horizontal crosstalk, so the difference of the horizontal crosstalk on the first, second, third, fourth, fifth and sixth points 1, 2, 3, 4, 5 and 6 is minimized. That is, the resistors of the first amplifying unit 152-1 (shown in FIG. 7) are calibrated.

Table II represents a relationship between a location of a point and the distortion amount after compensation for the distortion amount.

TABLE II

| Number | Box-Shaped Image | | Horizontal Crosstalk |
|---|---|---|---|
| of Point | (Yes/No) | Luminance | (%) |
| 1 | Yes | 32.44 | 2.04 |
| | No | 31.79 | |
| 2 | Yes | 31.75 | 0.06 |
| | No | 31.73 | |
| 3 | Yes | 29.45 | −2.09 |
| | No | 30.08 | |
| 4 | Yes | 28.19 | −1.91 |
| | No | 28.74 | |
| 5 | Yes | 27.08 | 0.30 |
| | No | 27.00 | |
| 6 | Yes | 27.02 | 2.23 |
| | No | 26.43 | |

For example, the resistors of the first amplifying unit 152-1 are adjusted, so the amount of horizontal crosstalk on each of the first, second, third, fourth, fifth and sixth points 1, 2, 3, 4, 5 and 6 is substantially zero. The resistance of the resistors is adjusted to change the first amplification ratio, thereby compensating for the distortion amount of the first common voltage VST. In Table II, the horizontal crosstalk is decreased, and the first common voltage VST is compensated.

In Tables I and II, the distortion amount of the first common voltage VST is compensated to reduce the latent image effect. Alternatively, the distortion amount of the second common voltage VCOM may be compensated to reduce the latent image effect. The distortion amounts of the first and second common voltages VST and VCOM may also be compensated to reduce the latent image effect.

According to the present invention, the distortion of the common voltage applied to the display panel is decreased, so the common voltage may have a constant level. In addition, the direct current portion of the common voltage on the pixel is decreased. Therefore, the latent image effect is reduced.

Furthermore, the image display quality is improved.

This invention has been described with reference to exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A display device comprising:
a display panel including a plurality of pixel units, each of the pixel units having a switching element and a storage capacitor electrically connected to the switching element;
a driving unit applying a driving signal to the switching element;
a common voltage generating unit applying a first common voltage to the storage capacitor; and
a first compensating unit that outputs a first compensation signal to the display panel to compensate a distorted portion of the first common voltage based on the first common voltage fed back from the display panel, the first compensating unit including:
a first feedback unit extracting the distorted portion of the first common voltage from the fed back first common voltage; and
a first amplifying unit that amplifies and inverts the distorted portion of the first common voltage to output the first compensation signal, the first amplifying unit including an operational amplifier and a resistor electrically connected to the operational amplifier to control a first amplification ratio of the first amplifying unit.

2. The display device of claim 1, wherein the first amplifying unit inverts a phase of the distorted portion of the first common voltage by about 180 degrees.

3. The display device of claim 1, wherein the first amplifying ratio is determined by an amount of crosstalk that is predetermined with respect to a location on the display panel.

4. The display device of claim 1, wherein the display panel further comprises a liquid crystal capacitor electrically connected to the switching element, and the common voltage generating unit applies a second common voltage to the liquid crystal capacitor.

5. The display device of claim 4, further comprising a second compensating unit that compensates a distorted portion of the second common voltage based on a second common voltage fed back from the display panel.

6. The display device of claim 5, wherein the second compensating unit comprises:
a second feedback unit extracting the distorted portion from the fed back second common voltage; and
a second amplifying unit that amplifies and inverts the distorted portion of the second common voltage to output the second common voltage.

7. The display device of claim 6, wherein the second amplifying unit inverts a phase of the distorted portion of the second common voltage by about 180 degrees.

8. The display device of claim 6, wherein the second amplifying unit comprises:
an auxiliary operational amplifier; and
an auxiliary resistor electrically connected to the auxiliary operational amplifier to control a second amplification ratio of the second amplifying unit.

9. The display device of claim 6, wherein the second amplifying ratio is determined by an amount of crosstalk that is predetermined with respect to a location on the display panel.

10. The display device of claim 5, wherein the second common voltage comprises a plurality of second common voltage portions having varied levels, and the second compensating unit outputs the second compensating signal based on a distorted portion of one of the fed back second common voltage portions.

11. A method of driving a display device including a display panel having a plurality of pixel units, each of the pixel units including a switching element, a liquid crystal capacitor electrically connected to the switching element and a storage capacitor, the method comprising:
generating an analog driving voltage;
applying a first common voltage to the storage capacitor and a second common voltage to the liquid crystal capacitor, wherein each voltage is based on the driving voltage;
feeding back a distorted portion of the first common voltage from the display panel; and
amplifying and inverting the distorted portion of the first common voltage based on a first amplifying ratio to output a first compensation signal to the display panel, thereby compensating the distorted portion of the first common voltage.

12. The method of claim 11, wherein inverting the distorted portion of the first common voltage comprises inverting a phase of the distorted portion of the first common voltage by about 180 degrees.

13. The method of claim 11, wherein the first common voltage comprises a plurality of first common voltage portions having varied levels with respect to locations on the display panel.

14. The method of claim 11, wherein the second common voltage comprises a plurality of second common voltage portions having varied levels with respect to a location on the display panel.

15. The method of claim 11, wherein the first amplifying ratio is determined by an amount of horizontal crosstalk that is predetermined with respect to a location on the display panel.

16. The method of claim 15, wherein the amount of horizontal crosstalk is determined based on a luminance on the location on the display panel.

17. The method of claim 16, wherein the first amplifying ratio is adjusted so the amount of horizontal crosstalk is substantially zero.

18. The method of claim 11, further comprising:
feeding back a distorted portion of the second common voltage from the display panel; and
compensating the distorted portion of the second common voltage based on a second amplifying ratio.

19. The method of claim 18, wherein the compensated first common voltage and the compensated second common voltage are selectively applied to the display panel.

20. A driving device for driving a display device including a display panel that displays an image based on data and gate signals and a first common voltage comprising:
a data driving unit generating a data signal;
a gate driving unit generating a gate signal;
a driving voltage generating unit generating an analog driving voltage; and
a compensating unit that applies a first common voltage to the display panel based on the analog driving voltage, receives feedback from the first common voltage, and outputs a first compensation signal that compensates a distorted portion of the first common voltage using the feedback from the first common voltage, the compensating unit including:
a feedback unit extracting the distorted portion of the first common voltage from the fed back first common voltage; and
an amplifying unit that amplifies and inverts the distorted portion of the first common voltage to output the first common voltage, the amplifying unit including an operational amplifier and a resistor electrically connected to the operational amplifier to control a first amplification ratio of the amplifying unit.

21. The driving device of claim 20, wherein the amplifying unit inverts a phase of the distorted portion of the first common voltage by about 180 degrees.

22. The driving device of claim 20, wherein the compensating unit further applies a second common voltage to the display panel based on the analog driving voltage, receives feedback from the second common voltage, and outputs a second compensation signal that compensates a distorted portion of the second common voltage using the feedback from the second common voltage.
